(19) United States
(12) Patent Application Publication
(10) Pub. No.: US 2010/0088754 A1
(43) Pub. Date: Apr. 8, 2010

(54) Authentication Method and Token Using Screen Light for Both Communication and Powering

(75) Inventor: Luca Ghislanzoni, Lecco (IT)

Correspondence Address: Luca Ghislanzoni;C-Sigma srl, via Cavour 18, Lecco, 23900, IT

(73) Assignee: KOROTED S.R.I., Seregno (IT)

(21) Appl. No.: 12/529,921

(22) PCT Filed: Dec. 12, 2007
(86) PCT No.: PCT/EP2007/010849

§ 371 Date: Sep. 4, 2009

(30) Foreign Application Priority Data
Mar. 7, 2007 (IT) MI2007A000453

(51) Int. Cl. G06F 21/00

(52) U.S. Cl. 726/9

(57) ABSTRACT

An authentication token one side of which features an array of solar cells, of a very thin and flexible type, whereas the opposite side features a display device. The method consists in encoding into a sequence of bright images, interlaced with less bright ones, the code sent by the server. By placing the token in front of the portion of the screen displaying said encoding sequence, the light collected by the array of solar cells it is sufficient to generate the energy required for supplying the token's microprocessor, while the variation in brightness are decoded as to reconstruct the digital word representing the code sent by the server. Said code is then processed by the microprocessor to generate a One Time Password, OTP, then displayed on the display device. The user would then enter said OTP on the login page.

The present invention describes a method and an apparatus to authenticate a user's identity, for gaining access to sensitive data and-or applications in a secure way, but without the need to insert the device into readers of any sort. Typical applications would for example be: internet remote shopping, remote home-banking and financial transactions, access to virtual private networks (VPNs), etc.

In a very useful embodiment, the apparatus would be integrated into a conventional credit card, as to enhance security while using said credit card for payment authorisation.

Several devices, known as authentication tokens, are commercially available which already feature similar functions, although obtained by other means. In particular, RSA Security Inc. and TRI-D Systems Inc. offer authentication tokens which generate One Time Passwords (OTPs), typically displayed on a Liquid Crystal Display (LCD), for authenticating a user identity when the user initiates a session to connect to a secure server from a client application. Existing authentication tokens generate OTPs in various way. A very common way, herewith called “Current Time Encryption”, consists in encrypting the token's clock 64-bit standard ISO representation of Current Time, by means of a token specific true Random Seed and a token specific Salt (practically a serial number), both known also to the secure server the client is trying to gain access to, to then generate a OTP every about 60 seconds (an example is the SecurID® token from RSA Security Inc.). By entering said OTP on the login page, the user identity is then verified at the secure server side. The server would then include procedures to correct for token's clocks running slower or faster than its own Current Time clock.

Another known way, herewith called “Challenge Code Encryption” would make use of a keypad on the authentication token itself, and by means of which a user can enter a one time Challenge Code sent by the server and displayed, for example, on the login page of the service the user is trying to gain access to. The token then encrypts said Challenge Code with a token specific true “Random Seed” and a token specific Salt, both also known to the secure server that the client is trying to gain access to, displaying then the resulting OTP on the LCD. By entering said OTP on the login page, the user identity is then verified at the secure server side.

Finally, yet another method would get away with the need for encryption algorithms at the token's side by simply storing in the token's EEPROM a lookup table containing several random OTPs, known only to the server and the token itself. At each login the server would then ask for the OTP stored at location x, which the token will then readily display.

The method and device disclosed by this patent can be used to implement “Current Time Encryption” and-or “Challenge Code Encryption” and-or “OTPs Table” types of authentication, whatever the choice of the detailed encryption algorithm. A typical embodiment would consist in a credit card size token, featuring on one side an array of solar cells (for example of the photovoltaic type), and on the other side a display device (ideally, of a thin and flexible type). After a user has entered the user ID, for example Alice, on the login page, the server displays a Challenge Code (or Current Time for the “Current Time Encryption” method), encoded in a sequence of bright and dark rectangles, which are then shown in an area of the screen approximately the size of a credit card. Alice can then lay the credit card size token against said image. The image light output is then sufficient to generate the energy required to power the Micro Processing Unit, MPU, contained within Alice's token, while at the same time the variations in the solar cells array output signal are processed by said MPU to decode the Challenge Code (or Current Time) sent by the server. Encrypting it together with the stored Random Seed and Salt, the MPU can then generate the OTP expected by the server.

To verify whether such method was already covered by existing patents, a world-wide search was carried out in major patents databases, yielding the following results:
PCT/US2004/004366 (referred to as D1, “Portable Acess Device”, Bloomberg LP, Feb. 13, 2004, discloses (FIG. 6) a portable access device capable of reading, by means of photosensors, modulated light signals from a computer monitor.
U.S. Pat. No. 5,777,903 (referred here as D2), “Solar Cell Powered Smart Card with Integrated Display and Interface Keypad”, Motorola Inc., Jul. 7, 1998, discloses a smart card including a MPU, a display, a keypad, an interface for signals exchange with an external system, and photovoltaic cells for providing power.
U.S. Pat. No. 4,916,296 (referred here as D3), “Light Modulating Smart Card”, D. A. Streck, Apr. 10, 1990, discloses a smart card in one version of which, “solar cell(s) carried by the smart card convert light incident thereon into power for the card. In a variation thereof, there is a light splitter for splitting the beam of light into a portion directed on the solar cell(s) for producing power and a portion directed through the light modulator.”
U.S. Pat. No. 4,978,840 (referred here as D4), “IC Card Having Energy Input and Data Exchange Elements on Opposite Sides Thereof”, T. Anegawa, Dec. 18, 1990, discloses an IC Card featuring one main surface with solar cells to generate power, and the other main surface with semiconductor photo-elements for contactless data exchange with an external reader.
U.S. Pat. No. 3,971,916 (referred here as D5), “Methods of Data Storage and Data Storage Systems”, R. Moreno, Jul. 27, 1976, discloses a card whereby “Coupling of the card and data-transfer means is effected optically by light-emitting diodes cooperating with photovoltaic piles, or by direct electrical contact”.

The device described in D1, although capable of decoding light modulated signals conveyed by images displayed on a PC monitor, it does so thanks to photosensors, still requiring the use of a battery for powering the signal conditioning and processing electronics.

Concerning the device described in D2, although D2 does not explicitly mention this possibility, such type of Smart Card could indeed also be used for “Challenge Code Encryption” type of authentications. Alice would digit on the card's keypad a “Challenge Code”, as displayed by the server on the login page, the MPU would then generate a OTP, which Alice would enter on said login page. However, most users would find simpler to lay a card against a rectangular image on the screen and just wait for the OTP to be generated and displayed on said card's display device, rather than type entries on a necessarily very small keypad. Furthermore, embedding a keypad in a credit card size device increases its manufacturing complexity, affecting cost and long term reliability.

D3, D4, and D5, all describe cards whereby optical means are used for both supplying energy to the card's circuitry, as well as for establishing data communication paths. However, for card interrogation and-or data exchange, they all require the card to be inserted in a suitable card reader specific to that particular type of card.

The present invention, instead, obtains similar capabilities by introducing a novel way to interrogate the authentication card, whereby the card is laid against an image on a computer screen, or other type of terminal, and whose light output is used both to supply energy to the card's internal circuitry, as well as to encode server's requests. A very convenient way to generate said sequence of images would consist in merging into a standard GIF animation a sequence of white rectangles suitably interleaved with black rectangles, but other equally effective methods can easily be imagined by the skilled in the art.

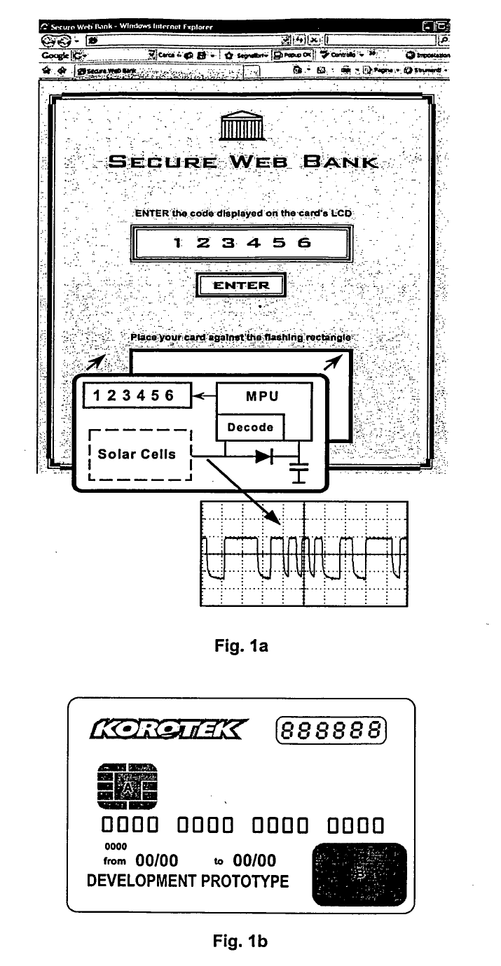

The inventive step of this invention is exemplified in FIG. 1a, whereas FIG. 1b depicts a practical example of how the token could be arranged for integration into a conventional credit card with smart chip (A). The shaded area B highlights one of the many possible location for mounting the solar cell(s).

Let us take the example of Alice connecting to a home banking service:
following a conventional procedure, the home banking service would ask for Alice's User ID, which Alice would enter to gain access to a login page of the kind shown in FIG. 1a.
On said page an area of approximately the size of a credit card displays a rapid sequence of bright images interleaved by dark ones, in a suitable way to encode the “Current Time” as broadcasted by the server (typically, with updates about every minute), or to encode a suitably generated one-time “Challenge Code”, that could also be periodically updated and broadcasted to all users, or could otherwise be specific to each user (depending on the details of the specific encryption algorithm utilised).
On the token's side facing said screen area, an array of solar cells convert the image's light output in electric energy, while intensity variations in said light are of sufficient amplitude as to allow simple and reliable decoding of the server's request, as shown in the oscilloscope recording inserted at the bottom of FIG. 1a (example obtained by recording the voltage output of a string of 4 cells of the type used in solar powered calculators, terminated on a suitable load)
The solar cells output is also used to recharge an energy storage element, such as for example the capacitor drawn in FIG. 1a, by means of suitable energy conditioning circuitry (schematically represented as a diode in FIG. 1a).
A Micro Processor Unit, MPU, can then draw its supply from said energy storage element, while a suitable DECODE interface circuitry, and associated software, allows decoding of the code embedded in the sequence of images.
The MPU has now all the data needed for computing the OTP, which is then shown on the token's display device.
Finally, Alice enters said OTP on the login page, gaining access to the required service.

It shall now be remarked that when using an encryption method based on a “Current Time” or “Challenge Code” common to all users, and periodically updated (for example every one minute or so), and whose encoding image is broadcasted on a TV channel, then secure home shopping for users without internet connection becomes possible (by dictating the OTP to the operator of the telephone number corresponding to that specific shopping or financial service).

The energy conditioning circuitry, schematically represented in FIG. 1a as a diode peak charging a capacitor, might indeed simply consist in a low drop Schottky rectifier, but more efficient and advanced solutions exist, and which are commonly known to the skilled in the art: MOSFET transistors driven as synchronous rectifiers, micropower switching mode boost converters capable to keep charging the energy storage element even at Vmin solar cells output, and all other obviously applicable solutions.

Suitable solar cells are commercially available, which are very thin and flexible, ideal characteristics for being integrated in credit card type of tokens. Computer screens and monitors can easily produce images with brightness in excess of 200 cd/m², so that less than about 10 cm² of total solar cells array area would typically generate sufficient energy. The skilled in the art can then figure out how to best connect the required number of solar cells, in conventional series and-or parallel configurations. Concerning the display device, several different technologies are nowadays available which allow the manufacturing of very thin and flexible displays.

A suitable micropower MPU would normally consume few tens of μW, requiring peaks of a couple of mW, lasting a couple of msec, only during EEPROM locations writing. Such peaks of energy demand can easily be buffered by a capacitor(s) totalling few μF, and which a suitable array of solar cells can recharge in less than one second of typical white screen light illumination. Naturally, the MPU would verify the amount of energy available (by monitoring the voltage across the storage capacitor) before starting any peak energy demanding task. The skilled in the art can therefore imagine several possible coding schemes producing a worst case total light output such as to always guarantee sufficient energy storage, while ensuring at the same time reliable and easy decoding. In particular, between two consecutive updates from the server, each coding sequence of bright and dark images could be repeated several times, or continuously, as to allow the MPU to verify multiple times the correct reading of the server's requests, while at the same time generating enough energy for the MPU needs. Of course, the dark image does not need to be pure black, but a best trade-off can be found by means of which:
colour and brightness of the bright image are selected to match, as far as possible, the solar cell(s) spectral response, as to guarantee that energy output is maximised, even under worst case conditions.
The dark image too could be optimised for colour and relative brightness (with respect to the bright image), as to guarantee reliable decoding while maximizing the total solar cell(s) energy output.

In a variation of the method, the modulations in brightness are detected by a separate photo sensing element, as to allow more flexibility in the detailed design of the coding scheme and of the circuitry for its decoding. A very convenient way to realise said photo sensing element could for example consist in reserving a fraction of the total area of the solar cells array as to obtain a very small cell dedicated to this purpose.

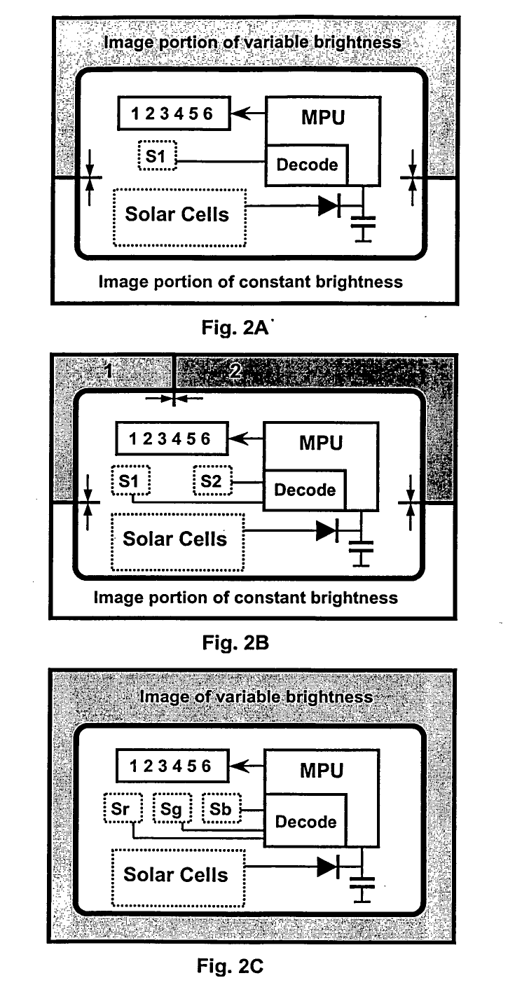

In a further variation of the method, a second constantly bright area could be placed just next to the screen area already displaying the sequence of images coding the server's requests. Some kind of reference lines and-or symbols drawn on the token would then help the user to correctly place it, for example by positioning said reference lines and-or symbols as to match the edge between said screen areas, as shown in FIG. 2A. In this way the solar cells will face the constantly bright area, while a photo sensing element mounted on the same side of the token, but with an offset with respect to the array of solar cells, will find itself facing the area of variable brightness. The corresponding apparatus would result more complex (because of the presence of one additional sensing element), but it would allow higher rates of data transfer.

Following a similar approach, FIG. 2B schematically illustrates a token featuring two photo sensing elements, each facing different portions of the screen, both of varying brightness, allowing more complex coding schemes to be implemented, such as for example:
one of the sensors could be used to convey a conventional CLOCK signal, to help in properly timing the sampling of the output signal of the other sensor, allowing hence to spare those time intervals, such as train of pulses and the like, usually required for periodic synchronisation by most serial communication protocols.
Another possible approach could consist in encoding the server's request into variations of the relative brightness between different screen portions and of varying brightness, so that by suitably subdividing into multiple discrete levels the analogue value of said relative brightness the overall data rate could be increased significantly.

It is then easy to figure out how the same approach could be extended to the use of 3 photo sensing elements, or 4, or 5, and so on. Although the number of sensors could in principle be arbitrarily extended, one must also consider that by subdividing the coding portion of the screen into more than 4 portions (for example 4 sectors separated by a cross) would make it progressively more cumbersome for the user to correctly position the token.

In yet another variation of the method, multiple individual sensors could be tuned to detect different portions of the emission spectrum of the images in the coding sequence, so that data could be coded also into the colour information. In a particularly straightforward embodiment three sensing elements, Sr, Sg, Sb, as shown in FIG. 2C, one for each of the three fundamental colours, red, green, blue, would decode variations in the brightness of each colour to transfer more bits at each sampling.

A very convenient way to realise photo sensing elements sensitive to defined portions of the coding image emission spectrum could for example consist in reserving a fraction of the total area of the solar cells array as to obtain a number of small cells dedicated to this purpose. Each cell would then be covered by an optical filter (in practice a coloured film of transparent plastic material) tuned to that particular portion of the emission spectrum.

The token specific Random Seed and Salt could be programmed into the MPU at the manufacturing stage, or also later on by using a similar method as used for reading server's requests from the screen, but carried out on a secure terminal (for example a workstation at a secure location), before delivery of the token to the customer. Such programming terminals could be chosen of a particularly bright type, so that the higher rate of energy generated by the solar cells would allow to considerably speed up the programming time required for each token. In an embodiment by which the token is integrated in a conventional smart card, the programming could take place also by means of the already present electrical contacts.

Concerning optimal coding schemes, no particular choice is detailed in this patent, as anyone skilled in the art can figure out several suitable solutions, and it would hence be too restrictive to bind the scope of this patent to a particular coding scheme.

Those skilled in the art will appreciate that several other useful features could be added, but which are of obvious derivation. An example is the possibility to implement software routines to provide the user with visual feedback on the token display device, such as the total number of times that the token has successfully decoded a “Current Time” or “Challenge Code”, or the like. With a “Current Time” type of encryption, a very simple way to provide said visual feedback would consist in displaying the most recent value of date and time as soon as it is decoded by the token, and just before the OTP is generated, so that the user can directly verify whether the displayed date and time values are the correct ones, and not future values as phishing sites would attempt to broadcast in order to “steal” future values of a token's OTPs. After that, the last recorded date and time value could also be displayed each time sufficient light illuminates the array of solar cells. If the recording, in the MPU EEPROM, of the last decoded “Current Time” value is allowed only when said value corresponds to a more recent time with respect to the one currently stored, then the user could easily verify:
whether token has been used, without the user knowing
whether the token was temporarily removed, without the user knowing, by somebody who then exposed it to sequences of images encoding for future values of the “Current Time, as to later be able to use, at said dates and times, the “stolen” OTPs.

In the case of the “OTPs Table” method, after displaying the OTP, the corresponding EEPROM location can be deleted, and a counter updated, so that various ways can now be imagined for providing visual feedback to the user on whether somebody has temporarily taken possession of the token, without him knowing, and tried to “steal” the OTPs (or only some of them), by presenting to the token coded images consecutively asking for the stored OTPs.

Of course, if instead a “Challenge Code Encryption” approach is preferred, whereby the server, at each login, randomly generate user specific Challenge Codes, phishing attempts would not produce any practical result.

The inventive step of this invention shall be understood as independent from a particular choice for the encryption algorithm, or coding scheme for the sequence of images, or visual feedback method, rather it consists in the idea of using the light output from the screen displaying the relevant login page, to convey both the server's requests and the energy needed to supply the token.

It shall be appreciated that those skilled in the art, building on the features of the invention described above, now could easily imagine many changes, modifications, and-or substitutions. The following claims are intended to cover such changes as fall within the scope of the inventive step detailed in the above description.

1. A contactless method to optically transfer server's requests to an authentication token, while at the same time supplying it with power, by means of the light emitted by portions of the screen, or monitor, displaying said server's login page;
characterised in that said method is arranged for
sending a code by the server by means of a time sequence of a bright image alternating with a dark image, said time sequence encoding said code as variations in the corresponding screen light output;
using an array of solar cells in the authentication token to convert said variations of the screen light output into a corresponding varying electric signal;
decoding the varying electric signal to obtain an input code;
using a Microprocessor Unit, MPU, which also includes a non volatile memory, to obtain a One Time Password, OTP, by applying an encryption method or by applying an OTP generation method using the obtained input code;
displaying said One Time Password on a suitable display device of the authentication token, so as to allow the user to enter it on the server's login page;
whereby the encoding time sequence of images is purposely arranged so as to guarantee that the corresponding light output is sufficient to generate, after its conversion by said array of solar cells, all the energy needed by the MPU for carrying out the required tasks.

2. Apparatus implementing the method described in claim 1, whereby the MPU with non volatile memory, the array of solar cells, the decoding circuitry, the display device, and energy storage capacitors, are embedded into a credit card size token, or into a conventional credit card, or into a conventional smart-card, with the array of solar cells mounted on the side meant to be exposed to the light emitted by the image of time varying brightness displayed on the screen and encoding the requests from the server.

3. Apparatus as claimed in claim 2, characterised in that a photo sensing element is added on the same side as the one on which the array of solar cells is mounted, and said photo sensing element is dedicated to the task of detecting the variations in the light emitted by the image of time varying brightness encoding the requests from the server, while said encoding pattern of time varying brightness is purposely arranged so as to guarantee that the corresponding overall light output captured by the array of solar cells is sufficient to generate all the energy needed by the MPU for carrying out the required tasks.

4-5. (canceled)

6. Apparatus as claimed in claim 2, characterised in that three photo sensing elements, each sensitive to one of the three fundamental Red-Green-Blue color components of standard RGB color monitors, are added on the same side as the one on which the array of solar cells is mounted, and each of said three photo sensing elements is dedicated to the task of detecting the variations of the corresponding color component of the light emitted by the image of time varying brightness, while said encoding pattern of time varying brightness is purposely arranged so as to guarantee that the corresponding overall light output captured by the array of solar cells is sufficient to generate all the energy needed by the MPU for carrying out the required tasks.

7. (canceled)

8. Apparatus as claimed in claims 2, 3, characterised in that card specific user identification means are added, be they of the known on-card keypads type, or of the known on-card biometric sensors type, in order to allow the user to identify himself with the card before starting the OTP generation process.
